(19) United States
(12) Patent Application Publication
(10) Pub. No.: US 2018/0070308 A1
(43) Pub. Date: Mar. 8, 2018

(54) METHOD AND DEVICE FOR SETTING AWAKE PERIOD OF DISCOVERY WINDOW IN WIRELESS COMMUNICATION SYSTEM

(71) Applicant: LG ELECTRONICS INC., Seoul (KR)

(72) Inventors: Hyunhee PARK, Seoul (KR); Dongcheol KIM, Seoul (KR); Byungjoo LEE, Seoul (KR); Giwon PARK, Seoul (KR); Taesung LIM, Seoul (KR)

(21) Appl. No.: 15/557,732

(22) PCT Filed: Aug. 14, 2015
(86) PCT No.: PCT/KR2015/008520

§ 371 Date: Sep. 12, 2017

Related U.S. Application Data
(60) Provisional application No. 62/134,602, filed on Mar. 18, 2015.
(60) Provisional application No. 62/135,719, filed on Mar. 20, 2015.
(60) Provisional application No. 62/135,718, filed on Mar. 20, 2015.

(51) Int. Cl. H04W 52/02; H04W 48/16; H04W 8/00

(52) U.S. Cl. CPC H04W 52/0216; H04W 72/0406; H04W 8/005; H04W 48/16

(57) ABSTRACT

The present specification relates to a method for setting an awake period of a discovery window in a wireless communication system. The method may comprise the steps of: setting a data group which comprises one or more master devices; and the master devices, included in the data group, setting an awake period of a discovery window. If the data group is a first data group, the awake period of the discovery window is set as a first period. If the data group is a second data group, the awake period of the discovery window is set as a second period.

### TECHNICAL FIELD

The present specification relates to a wireless communication system, and more particularly, to a method of setting an awake period of a discovery window in a wireless communication system and an apparatus therefor.

### BACKGROUND ART

Wireless access systems have been widely deployed to provide various types of communication services such as voice or data. In general, a wireless access system is a multiple access system that may support communication of multiple users by sharing available system resources (e.g., a bandwidth, transmission power, etc.). For example, multiple access systems include a Code Division Multiple Access (CDMA) system, a Frequency Division Multiple Access (FDMA) system, a Time Division Multiple Access (TDMA) system, an Orthogonal Frequency Division Multiple Access (OFDMA) system, a Single Carrier Frequency Division Multiple Access (SC-FDMA) system, and a multi carrier frequency division multiple access (MC-FDMA) system.

Recently, various wireless communication technologies have been developed with the advancement of information communication technology. Among the wireless communication technologies, a wireless local area network (WLAN) is the technology capable of accessing the Internet by wireless in a home, a company or a specific service provided area through portable device such as a personal digital assistant (PDA), a laptop computer, a portable multimedia player (PMP), etc. based on a radio frequency technology.

DISCLOSURE OF THE INVENTION

### Technical Tasks

A technical task of the present specification is to provide a method of setting an awake period of a discovery window in a wireless communication system and an apparatus therefor.

Another technical task of the present specification is to provide a method of reducing power consumption by awaking a discovery window based on a prescribed period in a wireless communication system.

The other technical task of the present specification is to provide a method of setting an awake period of a discovery window according to a data group based on data communication between devices in a wireless communication system.

### Technical Solution

To achieve these and other advantages and in accordance with the purpose of the present invention, as embodied and broadly described, according to one embodiment, a method of setting an awake period of a discovery window (DW), which is set by a NAN (neighbor awareness networking) device in a wireless communication system, can include the steps of setting a data group including at least one master device (master device), and setting the awake period of the discovery window, which is set by the master device included in the data group. In this case, if the data group corresponds to a first data group, the awake period of the discovery window is configured by a first period. If the data group corresponds to a second data group, the awake period of the discovery window can be configured by a second period.

To further achieve these and other advantages and in accordance with the purpose of the present invention, according to a different embodiment, a NAN (neighboring awareness networking) device setting an awake period of a discovery window (DW) in a wireless communication system can include a reception module configured to receive information from an external device, a transmission module configured to transmit information to an external device, and a processor configured to control the reception module and the transmission module, the processor configured to set a data group including at least one non-master device, the processor configured to set the awake period of the discovery window, the processor configured to transmit information on the awake period of the discovery window to the at least one non-master device included in the data group using the transmission module. In this case, if the data group corresponds to a first data group, the awake period of the discovery window can be configured by a first period. If the data group corresponds to a second data group, the awake period of the discovery window can be configured by a second period.

Following items can be commonly applied to a method of setting an awake period of a discovery window and a NAN device in a wireless communication system.

The awake period of the discovery window can be configured based on a discovery window set including a plurality of discovery windows.

The data group further includes at least one non-master device, the master device is awake in all discovery windows included in the discovery window set, and the non-master device can be awake in a part of the discovery windows included in the discovery window set based on the awake period of the discovery window.

Both the master device and the at least one non-master device can be awake in a first discovery window included in the discovery window set.

The first discovery window included in the discovery window set may have a duration longer than a duration of a different discovery window included in the discovery window set.

When the master device is awake in the all discovery windows of the discovery window set, the master device can be synchronized with an anchor master device.

The master device and the non-master device may not change a role during a first discovery window period and the first discovery window period can include n number of discovery windows.

The master device and the non-master device included in the same data group can exchange information on the awake period of the discovery window with each other by exchanging a service discovery frame.

The service discovery frame can further include information on a frequency used by the master device and the non-master device.

The first data group and the second data group are included in the same cluster and the first data group can be distinguished from the second data group based on a data attribute. In this case, the awake period of the discovery window is set based on a data attribute and the data attribute can be configured based on a latency requirement and a throughput requirement for a data service.

### Advantageous Effects

According to the present specification, it is able to provide a method of setting an awake period of a discovery window in a wireless communication system and an apparatus therefor.

According to the present specification, it is able to provide a method of reducing power consumption by awaking a discovery window based on a prescribed period in a wireless communication system.

According to the present specification, it is able to provide a method of setting an awake period of a discovery window according to a data group based on data communication between devices in a wireless communication system.

Effects obtainable from the present invention are non-limited by the above mentioned effect. And, other unmentioned effects can be clearly understood from the following description by those having ordinary skill in the technical field to which the present invention pertains.

### DESCRIPTION OF DRAWINGS

FIG. 1 is a diagram illustrating an exemplary structure of IEEE 802.11 system;

FIGS. 2 and 3 are diagrams illustrating examples of a NAN cluster;

FIG. 4 illustrates an example of a structure of a NAN device;

FIGS. 5 and 6 illustrate relations between NAN components;

FIG. 7 is a diagram illustrating a state transition of a NAN device;

FIG. 8 is a diagram illustrating a discovery window and the like;

FIG. 9 is a diagram illustrating a discovery window;

FIG. 10 is a diagram illustrating a method of differently setting an awake period of a discovery window according to a data group;

FIG. 11 is a diagram for a method of forming a data group based on a data attribute in a cluster;

FIG. 12 is a diagram for a method of setting an awake period of a discovery window of a non-master NAN device in each master group;

FIG. 13 is a diagram for a method of setting an awake period of a discovery window of a non-master NAN device in each data group;

FIG. 14 is a diagram for a method of setting duration of a first discovery window among a set of discovery windows;

FIG. 15 is a diagram for a method of setting an awake period of a discovery window of a non-master NAN device in each data group;

FIG. 16 is a flowchart for a method of setting an awake period of a discovery window according to one embodiment of the present specification;

FIG. 17 is a block diagram for a device according to one embodiment of the present specification.

### BEST MODE

Reference will now be made in detail to the preferred embodiments of the present invention, examples of which are illustrated in the accompanying drawings. The detailed description, which will be given below with reference to the accompanying drawings, is intended to explain exemplary embodiments of the present invention, rather than to show the only embodiments that can be implemented according to the present invention. The following detailed description includes specific details in order to provide the full understanding of the present invention. However, it will be apparent to those skilled in the art that the present invention may be implemented without such specific details.

The following embodiments can be achieved by combinations of structural elements and features of the present invention in prescribed forms. Each of the structural elements or features should be considered selectively unless specified separately. Each of the structural elements or features may be carried out without being combined with other structural elements or features. Also, some structural elements and/or features may be combined with one another to constitute the embodiments of the present invention. The order of operations described in the embodiments of the present invention may be changed. Some structural elements or features of one embodiment may be included in another embodiment, or may be replaced with corresponding structural elements or features of another embodiment.

Specific terminologies in the following description are provided to help the understanding of the present invention. And, these specific terminologies may be changed to other formats within the technical scope or spirit of the present invention.

Occasionally, to avoid obscuring the concept of the present invention, structures and/or devices known to the public may be skipped or represented as block diagrams centering on the core functions of the structures and/or devices. In addition, the same reference numbers will be used throughout the drawings to refer to the same or like parts in this specification.

The embodiments of the present invention can be supported by the disclosed standard documents disclosed for at least one of wireless access systems including IEEE 802 system, 3GPP system, 3GPP LTE system, LTE-A (LTE-Advanced) system and 3GPP2 system. In particular, the steps or parts, which are not explained to clearly reveal the technical idea of the present invention, in the embodiments of the present invention may be supported by the above documents. Moreover, all terminologies disclosed in this document can be supported by the above standard documents.

The following embodiments of the present invention can be applied to a variety of wireless access technologies, for example, CDMA (code division multiple access), FDMA (frequency division multiple access), TDMA (time division multiple access), OFDMA (orthogonal frequency division multiple access), SC-FDMA (single carrier frequency division multiple access) and the like. CDMA can be implemented with such a radio technology as UTRA (universal terrestrial radio access), CDMA 2000 and the like. TDMA can be implemented with such a radio technology as GSM/GPRS/EDGE (Global System for Mobile communications)/General Packet Radio Service/Enhanced Data Rates for GSM Evolution). OFDMA can be implemented with such a radio technology as IEEE 802.11 (Wi-Fi), IEEE 802.16 (WiMAX), IEEE 802.20, E-UTRA (Evolved UTRA), etc.

Although the terms such as “first” and/or “second” in this specification may be used to describe various elements, it is to be understood that the elements are not limited by such terms. The terms may be used to identify one element from another element. For example, a first element may be referred to as a second element, and vice versa within the range that does not depart from the scope of the present invention.

In the specification, when a part “comprises” or “includes” an element, it means that the part further comprises or includes another element unless otherwise mentioned. Also, the terms “..unit”, “...module” disclosed in the specification means a unit for processing at least one function or operation, and may be implemented by hardware, software or combination of hardware and software.

For clarity, the following description focuses on IEEE 802.11 systems. However, technical features of the present invention are not limited thereto.

Structure of WLAN System

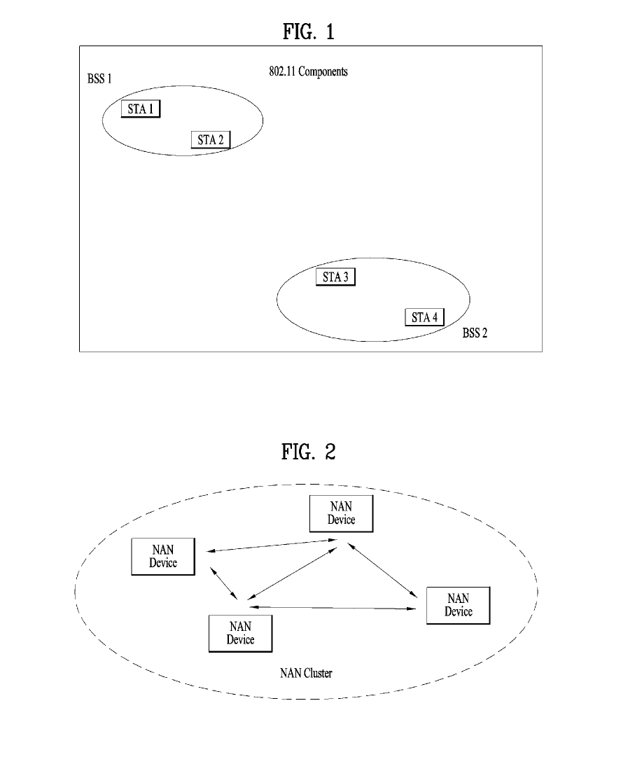

FIG. 1 is a diagram illustrating an exemplary structure of IEEE 802.11 system to which the present invention is applicable.

IEEE 802.11 structure may include a plurality of components and WLAN supportive of transparent STA mobility for an upper layer can be provided by interactions between the components. A basic service set (BSS) may correspond to a basic component block in IEEE 802.11 WLAN. FIG. 1 shows one example that two basic service sets BSS 1 and BSS 2 exist and that 2 STAs are included as members of each BSS. In particular, STA 1 and STA 2 are included in the BSS 1 and STA 3 and STA 4 are included in the BSS 2. In FIG. 1, an oval indicating the BSS can be understood as indicating a coverage area in which the STAs included in the corresponding BSS maintain communication. This area may be called a basic service area (BSA). Once the STA moves out of the BSA, it is unable to directly communicate with other STAs within the corresponding BSA.

A most basic type of BSS in IEEE 802.11 WLAN is an independent BSS (IBSS). For instance, IBSS can have a minimum configuration including 2 STAs only. Moreover, the BSS (e.g., BSS 1 or BSS 2) shown in FIG. 1, which has the simplest configuration and in which other components are omitted, may correspond to a representative example of the IBSS. Such a configuration is possible if STAs can directly communicate with each other. Moreover, the above-mentioned WLAN is not configured according to a devised plan but can be configured under the necessity of WLAN. And, this may be called an ad-hoc network.

If an STA is turned on/off or enters/escapes from a BSS area, membership of the STA in a BSS can be dynamically changed. In order to obtain the membership of the BSS, the STA can join the BSS using a synchronization procedure. In order to access all services of the BSS based structure, the STA should be associated with the BSS. This association may be dynamically configured or may include a use of a DSS (distribution system service).

Additionally, FIG. 1 shows components such as a DS (distribution system), a DSM (distribution system medium), an AP (access point) and the like.

In WLAN, a direct station-to-station distance can be restricted by PHY capability. In some cases, the restriction of the distance may be sufficient enough. However, in some cases, communication between stations located far away from each other may be necessary. In order to support extended coverage, the DS (distribution system) may be configured.

The DS means a structure in which BSSs are interconnected with each other. Specifically, the BSS may exist as an extended type of component of a network consisting of a plurality of BSSs instead of an independently existing entity as shown in FIG. 1.

The DS corresponds to a logical concept and can be specified by a characteristic of the DSM. Regarding this, IEEE 802.11 standard logically distinguishes a wireless medium (WM) from the DSM. Each of the logical media is used for a different purpose and is used as a different component. According to the definition of the IEEE 802.11 standard, the media are not limited to be identical to each other or to be different from each other. Since a plurality of the media are logically different from each other, flexibility of IEEE 802.11 WLAN structure (a DS structure or a different network structure) can be explained. In particular, the IEEE 802.11 WLAN structure can be implemented in various ways and the WLAN structure can be independently specified by a physical characteristic of each implementation case.

The DS can support a mobile device in a manner of providing seamless integration of a plurality of BSSs and logical services necessary for handling an address to a destination.

The AP enables associated STAs to access the DS through the WM and corresponds to an entity having STA functionality. Data can be transferred between the BSS and the DS through the AP. For instance, as shown in FIG. 1, while each of the STA 2 and STA 3 have STA functionality, the STA 2 and STA 3 provide functions of enabling associated STAs (STA 1 and STA 4) to access the DS. And, since all APs basically correspond to an STA, all APs correspond to an addressable entity. An address used by the AP for communication in the WM should not be identical to an address used by the AP for communication in the DSM.

Data transmitted from one of STAs associated with an AP to an STA address of the AP is always received in an uncontrolled port and the data can be processed by an IEEE 802.1X port access entity. Moreover, if a controlled port is authenticated, transmission data (or frame) can be delivered to a DS.

Layer Structure

Operations of the STA which operates in a wireless LAN system can be explained in terms of the layer structure. In terms of a device configuration, the layer structure can be implemented by a processor. The STA may have a structure of a plurality of layers. For example, a main layer structure handled in the 802.11 standard document includes a MAC sublayer and a physical (PHY) layer on a data link layer (DLL). The PHY layer may include a physical layer convergence procedure (PLCP) entity, a physical medium dependent (PMD) entity, etc. The MAC sublayer and the PHY layer conceptually include management entities called MAC sublayer management entity (MLME) and physical layer management entity (PLME), respectively. These entities provide a layer management service interface for performing a layer management function.

A station management entity (SME) is present within each STA in order to provide an accurate MAC operation. The SME is a layer-independent entity that may be considered as existing in a separate management plane or as being off to the side. Detailed functions of the SME are not specified in this document but it may be generally considered as being responsible for functions of gathering layer-dependent status from the various layer management entities (LMEs), setting values of layer-specific parameters similar to each other. The SME may perform such functions on behalf of general system management entities and may implement a standard management protocol.

The aforementioned entities interact with each other in various ways. For example, the entities may interact with each other by exchanging GET/SET primitives. The primitive means a set of elements or parameters related to a specific purpose. XX-GET.request primitive is used for requesting a value of a given MIB attribute (management information based attribute). XX-GET.confirm primitive is used for returning an appropriate MIB attribute value if a status is ‘success’, otherwise it is used for returning an error indication in a status field. XX-SET.request primitive is used to request that an indicated MIB attribute be set to a given value. If this MIB attribute implies a specific action, this requests that the action be performed. And, XX-SET.confirm primitive is used such that, if the status is ‘success’, this confirms that the indicated MIB attribute has been set to the requested value, otherwise it is used to return an error condition in the status field. If this MIB attribute implies a specific action, this confirms that the action has been performed.

Moreover, the MLME and the SME may exchange various MLME_GET/SET primitives through an MLME SAP (service access point). Furthermore, various PLME_GET/SET primitives may be exchanged between the PLME and the SME through PLME_SAP and may be exchanged between the MLME and the PLME through an MLME-PLME_SAP.

NAN (Neighbor Awareness Network) Topology

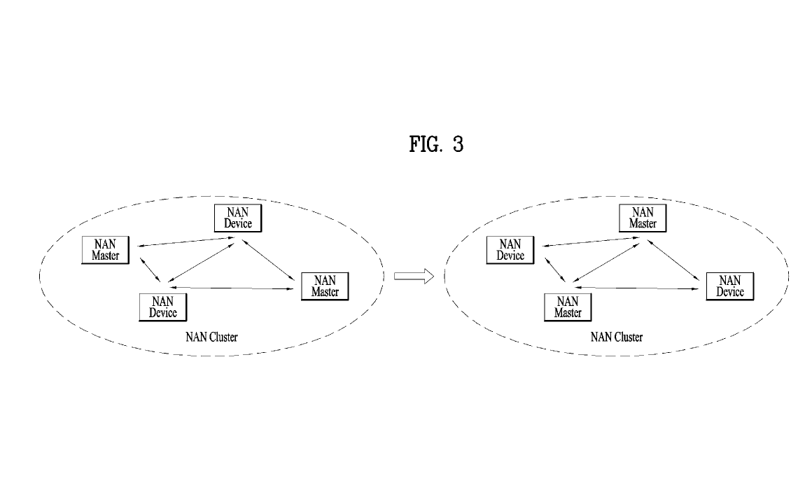

A NAN network can be constructed with NAN devices (terminals) that use a set of identical NAN parameters (e.g., a time interval between consecutive discovery windows, an interval of a discovery window, a beacon interval, a NAN channel, etc.). A NAN cluster can be formed by NAN devices and the NAN cluster means a set of NAN devices that are synchronized on the same discovery window schedule. And, a set of the same NAN parameters is used in the NAN cluster. FIG. 2 illustrates an example of the NAN cluster. A NAN device included in the NAN cluster may directly transmit a multicast/unicast service discovery frame to a different NAN device within a range of the discovery window. As shown in FIG. 3, at least one NAN master may exist in a NAN cluster and the NAN master may be changed. Moreover, the NAN master may transmit all of a synchronization beacon frame, discovery beacon frame and service discovery frame.

NAN Device Architecture

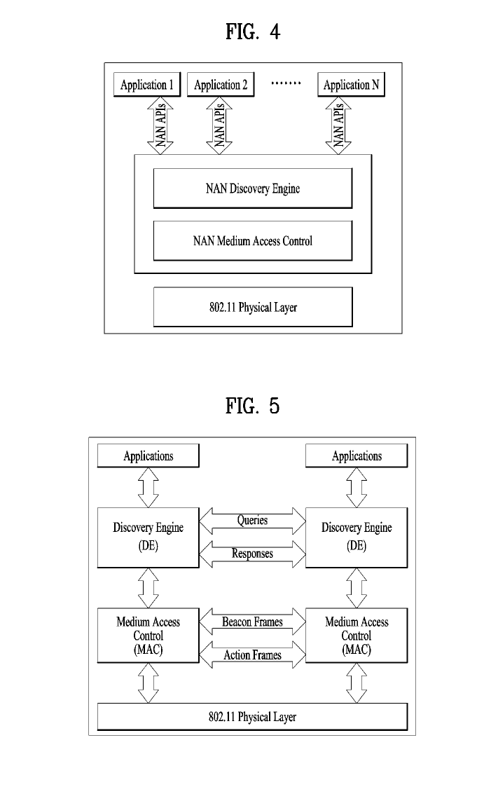

FIG. 4 illustrates an example of a structure of a NAN device (terminal). Referring to FIG. 4, the NAN device is based on a physical layer in 802.11 and its main components correspond to a NAN discovery engine, a NAN MAC (medium access control), and NAN APIs connected to respective applications (e.g., Application 1, Application 2, . . . , Application N).

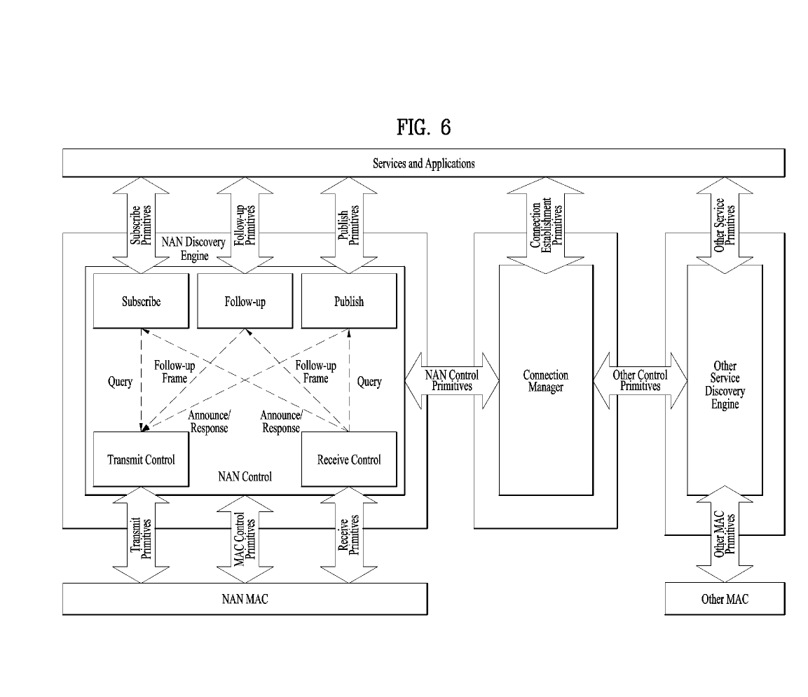

FIGS. 5 and 6 illustrate relations between NAN components. Service requests and responses are processed through the NAN discovery engine, and the NAN beacon frames and the service discovery frames are processed by the NAN MAC. The NAN discovery engine may provide functions of subscribing, publishing, and following-up. The publish/subscribe functions are operated by services/applications through a service interface. If the publish/subscribe commands are executed, instances for the publish/subscribe functions are generated. Each of the instances is driven independently and a plurality of instances can be driven simultaneously in accordance with the implementation. The follow-up function corresponds to means for the services/applications that transceive specific service information.

Role and State of NAN device

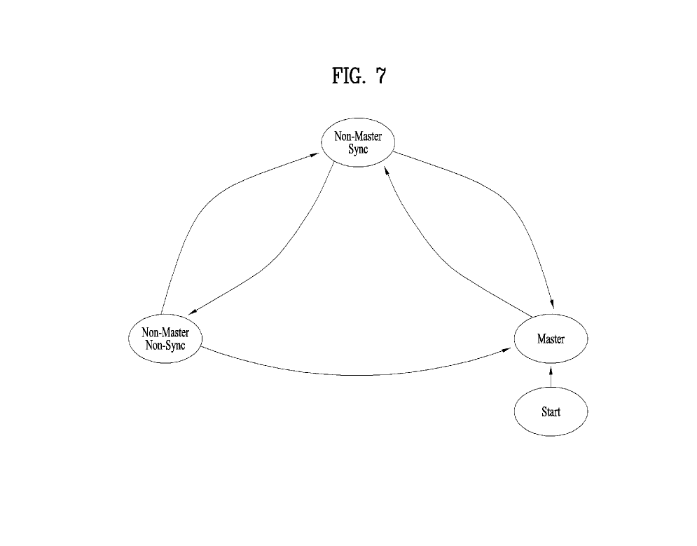

As mentioned in the foregoing description, a NAN device (terminal) can serve as a NAN master and the NAN master can be changed. In other words, roles and states of the NAN device can be shifted in various ways and related examples are illustrated in FIG. 7. The roles and states, which the NAN device can have, may include a master (hereinafter, the master means a state of master role and sync), a Non-master sync, and a Non-master Non-sync. Transmission availability of the discovery beacon frame and/or the synchronization beacon frame can be determined according to each of the roles and states and it may be set as illustrated in Table 1.

TABLE 1

| | | Synchronization |
|---|---|---|
| Role and State | Discovery Beacon | Beacon |
| Master | Transmission | Transmission |
| | Possible | Possible |
| Non-Master Sync | Transmission | Transmission |
| | Impossible | Possible |
| Non-Master Non- | Transmission | Transmission |
| Sync | Impossible | Impossible |

The state of the NAN device can be determined according to a master rank (MR). The master rank indicates the preference of the NAN device to serve as the NAN master. In particular, a high master rank means strong preference for the NAN master. The NAN MR can be determined by Master Preference, Random Factor, Device MAC address, and the like according to Formula 1.

MasterRank=MasterPreference*2⁵⁶+RandomFactor*2 ⁴⁸−MAC[5]*2⁴⁰+ . . . +MAC[0] [Formula 1]

In Formula 1, the Master Preference, Random Factor, Device MAC address may be indicated through a master indication attribute. The master indication attributes may be set as illustrated in Table 2.

TABLE 2

| Field Name | Size (Octets) | Value | Description |
|---|---|---|---|
| Attribute ID | 1 | 0x00 | Identifies |
| | | | the type of NAN |
| | | | attribute. |
| Length | 2 | 2 | Length of |
| | | | the following field in |
| | | | the attribute |
| Master | 1 | 0-255 | Information |
| Preference | | | that is used to |
| | | | indicate a NAN |
| | | | Device's preference |
| | | | to serve as the role |
| | | | of Master, with a |
| | | | larger value |
| | | | indicating a higher |
| | | | preference. |
| Random | 1 | 0-255 | A random |
| Factor | | | number selected by |
| | | | the sending NAN |
| | | | Device. |

Regarding the above MR, in case of a NAN device that activates a NAN service and initiates a NAN cluster, each of the Master Preference and the Random Factor is set to 0 and NANWarmUp is reset. The NAN device should set a Master Preference field value in the master indication attribute to a value greater than 0 and a Random Factor value in the master indication attribute to a new value until when the NANWarmUp expires. When a NAN device joins a NAN cluster in which the Master Preference of an anchor master is set to a value greater than 0, the corresponding NAN device may set the Master Preference to a value greater than 0 and the Random Factor to a new value irrespective of expiration of the NANWarmUp.

Moreover, a NAN device can become an anchor master of a NAN cluster depending on an MR value. That is, all NAN devices have capabilities of operating as the anchor master. The anchor master means the device that has a highest MR and a smallest AMBTT (anchor master beacon transmit time) value and has a hop count (HC) (to the anchor master) set to 0 in the NAN cluster. In the NAN cluster, two anchor masters may exist temporarily but a single anchor master is a principle of the NAN cluster. If a NAN device becomes an anchor master of a currently existing NAN cluster, the NAN device adopts TSF used in the currently existing NAN cluster without any change.

The NAN device can become the anchor master in the following cases: if a new NAN cluster is initiated; if the master rank is changed (e.g., if an MR value of a different NAN device is changed or if an MR value of the anchor master is changed); or if a beacon frame of the current anchor master is not received any more. In addition, if the MR value of the different NAN device is changed or if the MR value of the anchor master is changed, the NAN device may lose the status of the anchor master. The anchor master can be determined according to an anchor master selection algorithm in the following description. In particular, the anchor master selection algorithm is the algorithm for determining which NAN device becomes the anchor master of the NAN cluster. And, when each NAN device joins the NAN cluster, the anchor master selection algorithm is driven.

If a NAN device initiates a new NAN cluster, the NAN device becomes the anchor master of the new NAN cluster. If a NAN synchronization beacon frame has a hop count in excess of a threshold, the NAN synchronization beacon frame is not used by NAN devices. And, other NAN synchronization beacon frames except the above-mentioned NAN synchronization beacon frame are used to determine the anchor master of the new NAN cluster.

If receiving the NAN synchronization beacon frame having the hop count equal to or less than the threshold, the NAN device compares an anchor master rank value in the beacon frame with a stored anchor master rank value. If the stored anchor master rank value is greater than the anchor master value in the beacon frame, the NAN device discards the anchor master value in the beacon frame. If the stored anchor master value is less than the anchor master value in the beacon frame, the NAN device newly stores values greater by 1 than the anchor master rank and the hop count included in the beacon frame and an AMBTT value in the beacon frame. If the stored anchor master rank value is equal to the anchor master value in the beacon frame, the NAN device compares hop counters. Then, if a hop count value in the beacon frame is greater than a stored value, the NAN device discards the received beacon frame. If the hop count value in the beacon frame is equal to (the stored value−1) and if an AMBTT value is greater than the stored value, the NAN device newly stores the AMBTT value in the beacon frame. If the hop count value in the beacon frame is less than (the stored value−1), the NAN device increases the hop count value in the beacon frame by 1. The stored AMBTT value is updated according to the following rules. If the received beacon frame is transmitted by the anchor master, the AMBTT value is set to the lowest four octets of time stamp included in the received beacon frame. If the received beacon frame is transmitted from a NAN master or non-master sync device, the AMBTT value is set to a value included in a NAN cluster attribute in the received beacon frame.

Meanwhile, a TSF timer of a NAN device exceeds the stored AMBTT value by more than 16*512 TUs (e.g., 16 DW periods), the NAN device may assume itself as an anchor master and then update an anchor master record. In addition, if any of MR related components (e.g., Master Preference, Random Factor, MAC Address, etc.) is changed, a NAN device not corresponding to the anchor master compares the changed MR with a stored value. If the changed MR of the NAN device is greater than the stored value, the corresponding NAN device may assume itself as the anchor master and then update the anchor master record.

Moreover, a NAN device may set anchor master fields of the cluster attributes in the NAN synchronization and discovery beacon frames to values in the anchor master record, except that the anchor master sets the AMBTT value to a TSF value of corresponding beacon transmission. The NAN device, which transmits the NAN synchronization beacon frame or the discovery beacon frame, may be confirmed that the TSF in the beacon frame is derived from the same anchor master included in the cluster attribute.

Moreover, a NAN device may adopt a TSF timer value in a NAN beacon received with the same cluster ID in the following case: i) if the NAN beacon indicates an anchor master rank higher than a value in an anchor master record of the NAN device; or ii) if the NAN beacon indicates an anchor master rank equal to the value in the anchor master record of the NAN device and if a hop count value and an AMBTT value in the NAN beacon frame are larger values in the anchor master record.

NAN Synchronization

NAN devices (terminals) participating in the same NAN Cluster may be synchronized with respect to a common clock. A TSF in the NAN cluster can be implemented through a distributed algorithm that should be performed by all the NAN devices. Each of the NAN devices participating in the NAN cluster may transmit NAN synchronization beacon frame (NAN sync beacon frame) according to the above-described algorithm. The NAN device may synchronize its clock during a discovery window (DW). A length of the DW corresponds to 16 TUs. During the DW, one or more NAN devices may transmit synchronization beacon frames in order to help all NAN devices in the NAN cluster synchronize their own clocks.

NAN beacon transmission is distributed. A NAN beacon frame is transmitted during a DW period existing at every 512 TU. All NAN devices can participate in generation and transmission of the NAN beacon according to their roles and states. Each of the NAN devices should maintain its own TSF timer used for NAN beacon period timing. A NAN synchronization beacon interval can be established by the NAN device that generates the NAN cluster. A series of TBTTs are defined so that the DW periods in which synchronization beacon frames can be transmitted are assigned exactly 512 TUs apart. Time zero is defined as a first TBTT and the discovery window starts at each TBTT.

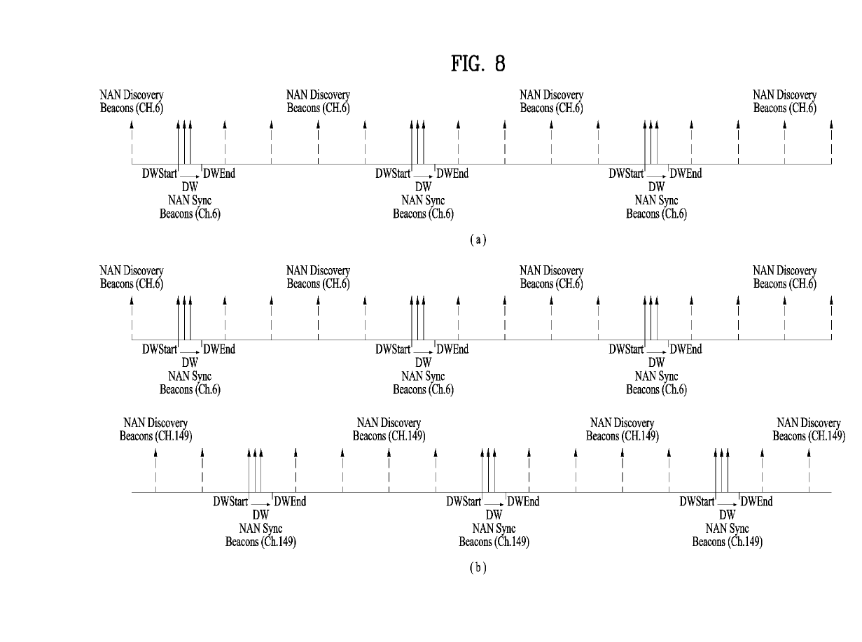

Each NAN device serving as a NAN master transmits a NAN discovery beacon frame from out of a NAN discovery window. On average, the NAN device serving as the NAN master transmits the NAN discovery beacon frame every 100 TUs. A time interval between consecutive NAN discovery beacon frames is smaller than 200 TUs. If a scheduled transmission time overlaps with a NAN discovery window of the NAN cluster in which the corresponding NAN device participates, the NAN device serving as the NAN master is able to omit transmission of the NAN discovery beacon frame. In order to minimize power required to transmit the NAN discovery beacon frame, the NAN device serving as the NAN master may use AC_VO (WMM Access Category-Voice) contention setting. FIG. 8 illustrates relations between a discovery window and a NAN discovery beacon frame and transmission of NAN synchronization/discovery beacon frames. Particularly, FIG. 8 (a) shows transmission of NAN discovery and synchronization beacon frames of a NAN device operating in 2.4 GHz band. FIG. 8 (b) shows transmission of NAN discovery and synchronization beacon frames of a NAN device operating in 2.4 GHz and 5 GHz bands.

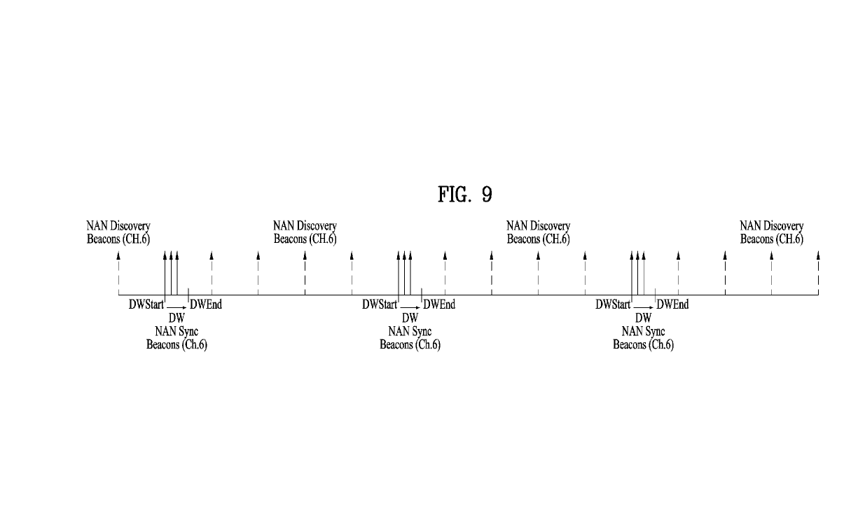

FIG. 9 is a diagram illustrating a discovery window. As mentioned in the foregoing description, each NAN device performing a master role transmits a synchronization beacon frame within a discovery window and transmits a discovery beacon frame at the outside of the discovery window. In this case, as mentioned in the foregoing description, the discovery window can be repeated in every 512 TU. In this case, duration of the discovery window may correspond to 16 TUs. In particular, the discovery window can last during 16 TUs. In this case, for example, all NAN devices belonging to a NAN cluster may awake at every discovery window to receive a synchronization beacon frame from a master NAN device. By doing so, the NAN cluster can be maintained. In this case, if all NAN devices awake at every discovery window in a fixed manner, power consumption of the devices may get worse. Hence, it is necessary to have a method of reducing power consumption by dynamically controlling duration of a discovery window while synchronization is maintained in a NAN cluster.

For example, as mentioned in the foregoing description, a NAN device may operate in 2.4 GHz band or 5 GHz band. As a different example, a NAN device may operate in sub 1 GHz band. For example, a NAN device can be configured to support IEEE 802.11ah that supports sub 1 GHz band. For example, if a NAN device supports 900 MHz, it may have link quality and a physical model different from link quality and a physical model in 2.4 GHz or 5 GHz. For example, if a NAN device supports 900 MHz, the NAN device can send a signal farther and perform communication in a wider range. In this case, data communication can be performed between NAN devices and data can be exchanged between NAN devices. In this case, since the data exchange is performed based on the data communication, a problem may exist in efficiently managing power in the NAN device. In order to solve the problem, it may differently configure a method of configuring a discovery window period. FIG. 9 shows a basic structure that a synchronization beacon frame is transmitted within a discovery window and a discovery beacon frame is transmitted at the outside of the discovery window. The basic structure can also be similarly applied to a NAN device supporting 900 MHz band.

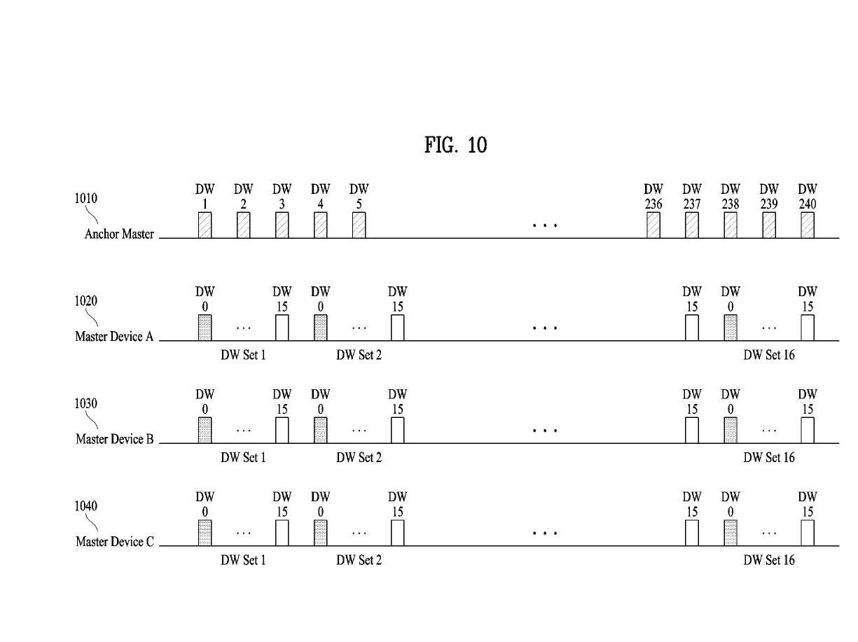

FIG. 10 is a diagram illustrating a method of differently setting an awake period of a discovery window according to a data group.

As mentioned in the foregoing description, a NAN device can switch to various roles and states. In this case, the NAN device can perform a role selected from the group consisting of an anchor master role, a master role, a non-master sync role, and a non-master non-sync role.

All NAN devices belonging to a cluster may become an anchor master NAN device 1010. In this case, synchronization in a cluster can be configured on the basis of the anchor master NAN device 1010. Since a master NAN device can transmits a synchronization beacon frame in a discovery window together with the anchor master NAN device 1010, the master NAN device can perform synchronization with other NAN devices. In particular, the master NAN device may correspond to a NAN device capable of performing synchronization by transmitting a synchronization beacon frame to a different NAN device.

A plurality of NAN devices can be included in a cluster. In this case, a plurality of the NAN devices included in a cluster can form a master group on the basis of the master NAN device. In particular, a master group can include a master NAN device performing a master role and at least one or more non-master NAN devices. In this case, for example, the non-master NAN devices can include NAN devices performing a non-master sync role only. And, for example, the non-master NAN devices can include NAN devices performing a non-master non-sync role only. As a different example, the non-master NAN devices can include a NAN device performing a non-master sync role and a NAN device performing a non-master non-sync role, by which the present invention may be non-limited.

For example, a master group can include a plurality of NAN devices performing a master role. In this case, for example, a plurality of the NAN devices included in the master group may be in a state that synchronization is matched with each other. In particular, a plurality of NAN devices performing a master role can be included in a master group, by which the present invention may be non-limited.

And, for example, when a NAN device performing a master role is included in a master group, the NAN device can match synchronization with an anchor master NAN device 1010. In particular, when a NAN device performing a non-master role is included in a master group, the NAN device performs synchronization via the NAN device performing the master role. The NAN device preforming the master role can perform synchronization via the anchor master NAN device 1010. In particular, it may be able to maintain a cluster via the abovementioned layer structure.

And, for example, the master NAN device performing the master role may not change a role and a state during a first discovery window period. In this case, the first discovery window period can include n number of discovery windows. In particular, the first discovery period may correspond to duration ranging from a start point of a first discovery window to an end point of an n^{th} discovery window. In this case, for example, the n may correspond to 240, by which the present invention may be non-limited.

In this case, since the master NAN device performing the master role does not change the role and the state, it may not change a master preference value and a random factor value. In particular, if a NAN device becomes a master NAN device by forming a master group, the NAN device performs a master role during a first discovery window without changing the aforementioned values and may be then able to match synchronization with a NAN device performing a non-mater role belonging to a master group. And, for example, non-master NAN devices may not change a role and a state during the first discovery window as well.

In this case, as mentioned in the foregoing description, NAN devices performing a role can change a role and a state under a prescribed condition. For example, if a NAN device fails to receive a synchronization beacon frame until 3 discovery windows are passed, the NAN device can change a role and a state of the NAN device. In particular, if synchronization is not performed until a prescribed number of discovery windows are passed, the NAN device can perform synchronization by changing a role of the NAN device.

However, if a master group is formed and a master NAN device does not change a role and a state of the master NAN device during the first discovery window period, non-master NAN devices may not change a role and a state of the non-master devices although a prescribed condition is satisfied. In this case, the non-master NAN devices are able to know that the non-master NAN device are synchronized via the master NAN device and may not change a role of the non-master NAN devices although the condition is satisfied. By doing so, it may be able to maintain a cluster. However, if it is not necessary for a non-master NAN device to match synchronization with a NAN device performing a master role anymore, although the first discovery window period is not elapsed, it may be able to configure the non-master NAN device to change a role and a state, by which the present invention may be non-limited.

And, for example, if non-master NAN devices receive a synchronization beacon frame or a different frame from a master NAN device, the non-master NAN devices are able to check that a master role is not changed during the first discovery window period via information included in the received frame. In this case, the non-master NAN devices may not change a role and a state as well. In particular, it may be able to reduce power consumption by making the non-master NAN devices operate in a low power mode.

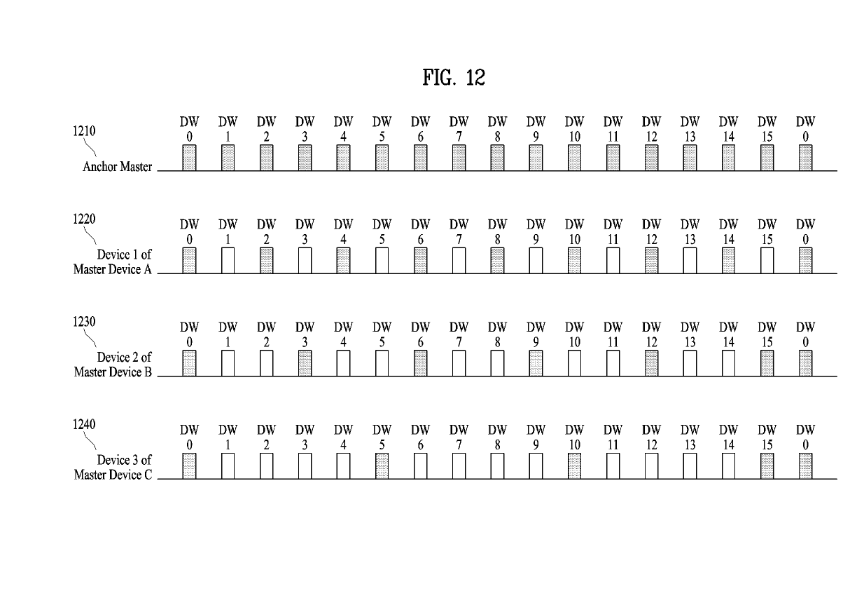

As mentioned in the foregoing description, if a master group is configured, it may be able to differently configure an awake period of a discovery window for NAN devices belonging to the master group. For example, a master NAN device belonging to the master group can be awake in every discovery window in a first discovery window period. In this case, the master NAN device is awake in every discovery window and may be able to perform synchronization with an anchor master NAN device 1010. And, a non-master NAN device belonging to the master group can be awake in a specific discovery window only based on a prescribed period. Regarding this, it shall be explained with reference to FIG. 12.

For example, referring to FIG. 10, a first discovery period may consist of 240 discovery windows. In this case, a master device A 1020 may correspond to a NAN device performing a master role in a first master group. And, a master device B 1030 may correspond to a NAN device performing a master role in a second master group. And, a master device C 1040 may correspond to a NAN device performing a master role in a third master group. In this case, NAN devices performing a non-master role in the first, second, and third master groups can be awake in a discovery window based on a different period. Yet, the anchor master device 1010, the master device A 1020, the master device B 1030, and the master device C 1040 can be awake in every discovery window. In this case, each of the master devices 1020/1030/1040 can be synchronized with the anchor master device 1010.

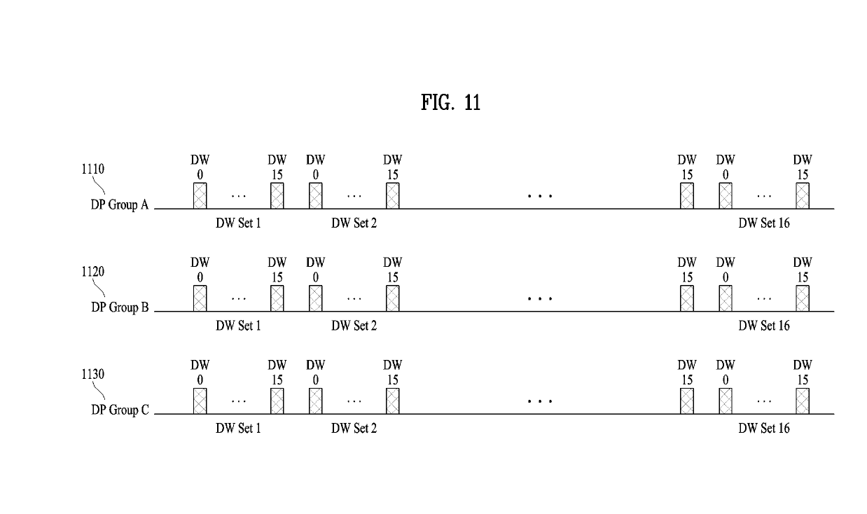

FIG. 11 is a diagram for a method of forming a data group based on a data attribute in a cluster.

As mentioned earlier in FIG. 10, a master group can be formed in a cluster on the basis of a master NAN device. In this case, the master group mat correspond to a data group. In particular, the master group mat correspond to a data group configured based on a data attribute. For example, a data group can be formed based on an application service or a data service on the basis of a master NAN device in a cluster.

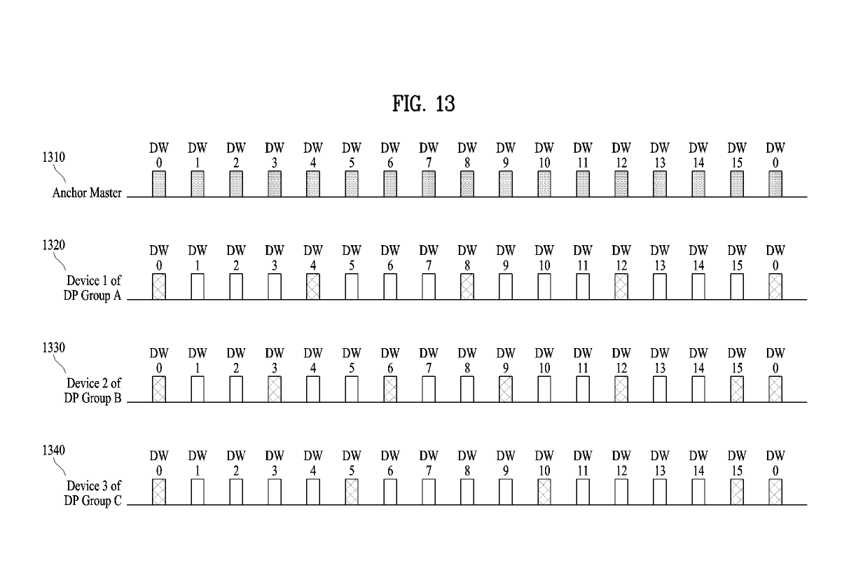

For example, a plurality of NAN devices can exchange data with each other in a cluster. In this case, a group can be formed based on NAN devices that exchange data. In particular, NAN devices exchanging a similar or identical data can form a data group. For example, a data group can be configured according to an attribute of an application service or a data service on the basis of a master NAN device in a cluster. In this case, a period of non-master NAN devices belonging to each data group can be determined based on a data attribute. Regarding this, it shall be explained later with reference to FIGS. 12 and 13.

Referring to FIG. 11, a data path group A 1110, a data path group B 1120, and a data path group C 1130 can be configured based on an application service, a data service, or the like in a cluster. In this case, for example, since data communication amount, delay requirement, and the like may vary between NAN devices, as mentioned in the foregoing description, it may be necessary to divide data group.

FIG. 12 is a diagram for a method of setting an awake period of a discovery window of a non-master NAN device in each master group.

Each of master groups (or data groups) can be configured in a cluster. In this case, the master group can be configured on the basis of a master NAN device performing a master role. In this case, the master NAN device is awake in every discovery window and can be synchronized with an anchor master NAN device 1210. Yet, a non-master NAN device included in the master group may not be awake in every discovery window. In this case, the master group can configure a discovery window set within the first discovery window period. The discovery window set may correspond to a set consisting of a prescribed number of discovery windows. For example, the discovery window set may include 16 discovery windows. In particular, the discovery window set can be configured by the prescribed number of discovery windows, by which the present invention may be non-limited. In this case, an awake period of a non-master NAN device belonging to a master group can be configured based on a discovery window set. The awake period of the non-master NAN device is configured in the discovery window set and it may restart the awake period of the non-master NAN device by resetting the awake period in a next discovery window set.

More specifically, when a master NAN device and a non-master NAN device belong to a master group, the master NAN device and the non-master NAN device can be awake in a first discovery window of a discovery window set. In this case, the master NAN device is synchronized with the non-master NAN device. Since the non-master NAN device recognizes that the non-master NAN device is synchronized with the master NAN device in the master group, the non-master NAN device may not change a role and a state of the non-master NAN device. Subsequently, the non-master NAN device can be awake in a discovery window away from the first discovery window as many as a prescribed number based on an awake period of a discovery window. In particular, the non-master NAN device stays in a sleep state after the first discovery window and can be awake when arrives at a specific discovery window.

Referring to FIG. 12, a first device 1220 of a first master group may correspond to a non-master NAN device. And, a second device 1230 of a second master group may correspond to a non-master NAN device. In this case, an awake period of a discovery window of the first device 1220 can be configured based on a first period. And, an awake period of a discovery window of the second device 1230 can be configured based on a second period. In particular, it may be able to configure a different period according to a master group. In this case, for example, both the first device 1220 and the second device 1230 can be awake in the first discovery window of a discovery window set. Subsequently, the first device 1220 can be awake in the third discovery window of the discovery window set based on the first period. In particular, the first device 1220 may sleep in the second discovery window of the discovery window set. Subsequently, the first device 1220 can be awake in the fifth discovery window of the discovery window set. In particular, the first period may correspond to a period that the first device is awake every two discovery windows.

And, the second device 1230 can be awake in the fourth and the seventh discovery windows of the discovery window set. In particular, the second period may correspond to a period that the second device is awake every three discovery windows. In particular, the first period of the first master group may differ from the second period of the second master group. In this case, both the first device 1220 and the second device 1230 can be awake in the first discovery window of the second discovery window set. In particular, if a period is applied to a discovery window set only and a discovery window set is newly started, all non-master NAN devices can be awake in the first discovery window of the discovery window set irrespective of a period.

And, for example, as mentioned in the foregoing description, information configured to make each master group has a different period can be exchanged between NAN devices via a service discovery frame (SDF). More specifically, a NAN device belonging to a cluster can transmit a service discovery frame to a different NAN device while a discovery window lasts. In this case, for example, the service discovery frame can be transmitted to a plurality of NAN devices belonging to a cluster via multicast. And, the service discovery frame can be transmitted to a single device via unicast. In this case, for example, a NAN device can transmit the service discovery frame to a different NAN device while a discovery window lasts irrespective of a role and a state of the NAN device. And, a plurality of service discovery frames can be transmitted via a discovery window or a plurality of discovery windows, by which the present invention may be non-limited. In particular, NAN devices belonging to a cluster can exchange a service discovery frame with each other while a discovery window lasts. In this case, as mentioned in the foregoing description, the service discovery frame can include period information on each master group. By doing so, NAN devices belonging to a cluster can identify an awake period. And, for example, the service discovery frame can further include information on a frequency used by the NAN devices. And, for example, the service discovery frame can further include information necessary for maintaining a cluster, by which the present invention may be non-limited.

FIG. 13 is a diagram for a method of setting an awake period of a discovery window of a non-master NAN device in each data group.

A master group may correspond to a data group. In this case, referring to FIG. 13, each of data groups can set an awake period of a discovery window of a non-master NAN device based on each period. In this case, for example, a period of a data group can be configured based on a data attribute of the data group. In this case, the data attribute may correspond to an attribute for a serviced application or data. For example, the data attribute can be configured based on whether or not data transmission is delayed, throughput, accuracy of data, and the like. More specifically, when a data group puts emphasis on whether or not data transmission is delayed as a data attribute, an awake period of a discovery window can be configured to be short. In particular, a non-master NAN device is frequently awake in a discovery window set to transmit and receive data and the like. On the contrary, if whether or not data transmission is delayed is not regarded as important, an awake period of a discovery window can be configured to be long.

And, for example, a data attribute can be determined according to a size of a data transport block and a period of a data transport block and a data group can determine an awake period of a discovery window. In particular, when data communication is performed between NAN devices, data throughput, a period, and the like may vary based on a characteristic of transmitted and received data or a characteristic of a provided application. A data application can be determined in consideration of the characteristics. An awake period of a discovery window can be determined by the determined data attribute

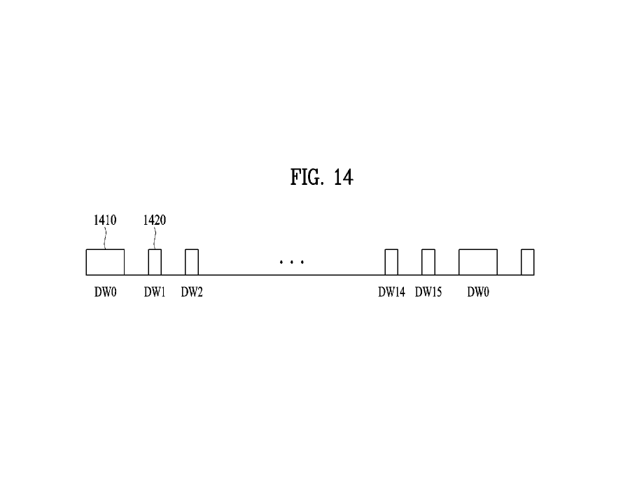

FIG. 14 is a diagram for a method of setting duration of a first discovery window among a set of discovery windows. A duration of a discovery window may correspond to 16TU. And, a discovery window can be defined in every period of 512TU. In particular, a time interval between adjacent discovery windows may correspond to 512TU. As mentioned in the foregoing description, a discovery window set can consist of a plurality of discovery windows. For example, a window set may include 16 discovery windows. A non-master NAN device can be awake in a specific discovery window only based on a prescribed period among discovery windows included in a discovery window set. And, the non-master NAN device can be awake in a first discovery window only included in the discovery window set. In particular, the non-master NAN device is awake in the first discovery window only of the discovery window set to perform synchronization and may be able to maintain a sleep state in the remaining discovery windows. By doing so, it may be able to reduce power consumption of a NAN device and obtain a low power efficiency gain.

In this case, for example, referring to FIG. 14, a duration of a first discovery window 1410 included in a discovery window set may be longer than a duration of a different discovery window 1420 included in the same discovery window set. In particular, the duration of the first discovery window 1410 may be longer than the duration of the different discovery window 1420 in the discovery window set. In this case, for example, the duration of the first discovery window 1410 may correspond to a prescribed multiple of 16TU. For example, the duration of the discovery window 1410 may correspond to 80TU (16TU*5). In this case, a duration of a different discovery window included in the discovery window set may correspond to 16TU. In particular, it may be able to configure the duration of the first discovery window 1410 to be longer than a duration of a different discovery window included in the same discovery window set. As mentioned in the foregoing description, a non-master NAN device can be mandatorily awake in the first discovery window 1410 of the discovery window set. In this case, the non-master NAN device can be synchronized with a master NAN device. In particular, since the first discovery window 1410 of the discovery window set plays a role in matching synchronization of the non-master NAN device, the first discovery window may correspond to the most important discovery window. In this case, if the duration of the first discovery window 1410 of the discovery window set is short, the duration of the discovery window may elapse in a state that the non-master NAN device and the master NAN device are not synchronized. In this case, since the non-master NAN device and the master NAN device are not properly synchronized, it may be difficult to smoothly perform data communication and the like. Hence, it is necessary to configure the duration of the first discovery window 1410 of the discovery window set to be longer than the duration of the different discovery window to make synchronization between the non-master NAN device and the master NAN device to be properly performed. The abovementioned configuration can be applied to a device supporting 900 MHz. For example, when data communication is performed between NAN devices via a low frequency band, the duration of the first discovery window of the discovery window set can be configured to be longer than the duration of the different discovery window included in the same discovery window set.

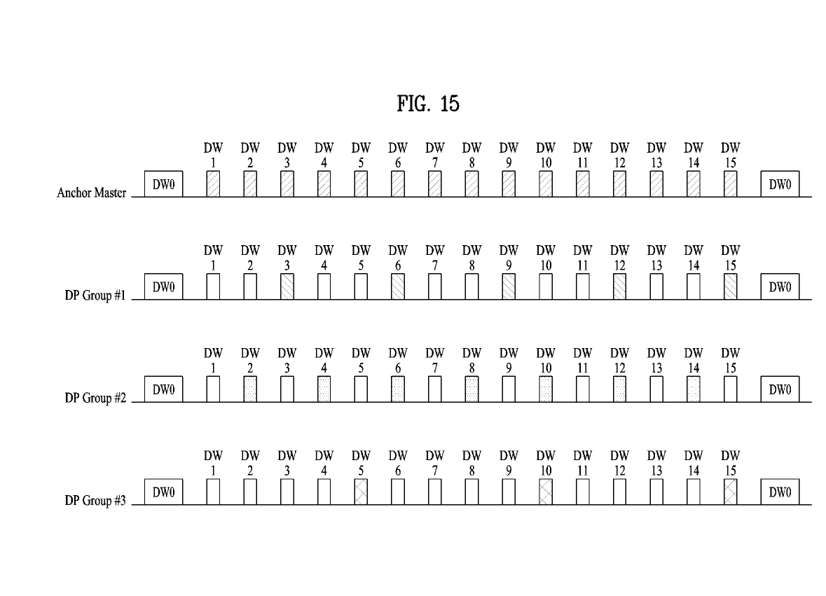

FIG. 15 is a diagram for a method of setting an awake period of a discovery window of a non-master NAN device in each data group. A data group (or master group) including a plurality of NAN devices can be formed in a cluster. In this case, the data group may have a prescribed period based on a data attribute in a discovery window set. In this case, a non-master NAN device can be awake in a specific discovery window only of the discovery window set based on the prescribed period.

Referring to FIG. 15, as mentioned earlier in FIG. 14, a duration of a first discovery can be longer than duration of other discovery windows in an anchor master 1510, a first data group 1520, a second data group 1530, and a third data group 1540. In this case, a first device belonging to the first data group 1520 can be awake in a fourth, a seventh, a tenth, a thirteenth, and a sixteenth discovery window of a discovery window set. In this case, since the discovery window set includes 16 discovery windows, the first device can be awake in a first discovery window of a next discovery window set after the sixteenth discovery window. In particular, the first data group 1520 may have a period for 3 discovery windows.

And, a second device belonging to the second data group 1530 can be awake in a third, a fifth, a seventh, a ninth, an eleventh, an thirteenth, and a fifteenth discovery window of a discovery window set. In this case, since the discovery window set includes 16 discovery windows, the second device can be awake in a first discovery window of a next discovery window set after the sixteenth discovery window. In particular, the second data group 1530 may have a period for 2 discovery windows.

And, a third device belonging to the third data group 1540 can be awake in a sixth, an eleventh, and a sixteenth discovery window of a discovery window set. In this case, since the discovery window set includes 16 discovery windows, the third device can be awake in a first discovery window of a next discovery window set after the sixteenth discovery window. In particular, the third data group 1540 may have a period for 5 discovery windows.

In particular, a data group can awake a NAN device performing a non-master role based on a period of the data group.

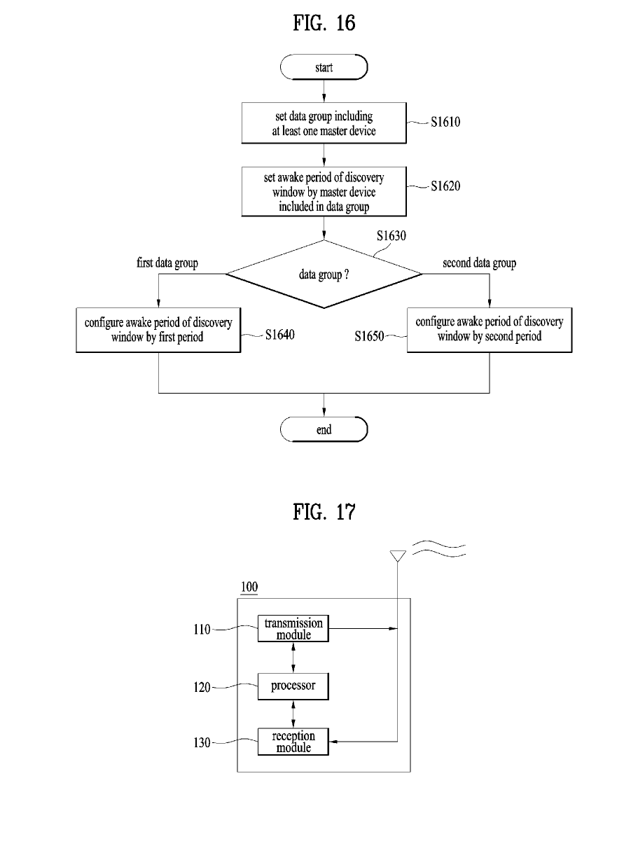

FIG. 16 is a flowchart for a method of setting an awake period of a discovery window according to one embodiment of the present specification.

A plurality of NAN devices can be included in a cluster. In this case, it may be able to configure a data group (or master group) including at least one master device [S1610]. In this case, as mentioned earlier in FIG. 10, the data group can further include at least one or more non-master NAN devices. For example, the non-master NAN device may correspond to a NAN device performing a non-master sync role or a NAN device performing a non-master non-sync role, by which the present invention may be non-limited. In this case, for example, the data group can be configured based on a data attribute. In this case, the data attribute can be configured based on a characteristic of a serviced application or a data.

Subsequently, a master NAN device included in the data group can configure an awake period of a discovery window [S1620]. As mentioned earlier in FIG. 12, the master NAN device included in the data group can configure an awake period of a discovery window of a non-master NAN device based on a discovery window set. In this case, the discovery window set can include discovery windows of a prescribed number. For example, the prescribed number may correspond to 16. In this case, the master NAN device can be awake in all discovery windows. By doing so, the master NAN device can be synchronized with an anchor master NAN device. And, all non-master NAN devices included in a data group can be awake in a first discovery window of a discovery window set. In this case, a non-master device can be synchronized with a master NAN device included in the same data group. The non-master device can be awake in a specific discovery window only based on a period which is configured after a first discovery window of the discovery window set. In this case, as mentioned in the foregoing description, if a next discovery window set arrives, all non-master NAN devices can be awake again in a first discovery window of the next discovery window set.

Subsequently, a discovery window period can be differently configured according to a data group [S1630]. In this case, if a data group corresponds to a first data group, a period of a discovery window can be configured by a first period [S1640]. And, if a data group corresponds to a second data group, a period of a discovery window can be configured by a second period. More specifically, since a data group has a different characteristic based on a different data attribute, it may be able to configure a data group to have a different period. As mentioned earlier in FIGS. 12 and 13, each data group may have a different period. In particular, an awake period of a specific discovery window can be differently configured in a discovery window set. In this case, for example, a period of a data group can be configured based on a data attribute of the data group. In this case, the data attribute may correspond to an attribute for a serviced application or data. For example, the data attribute can be configured based on whether or not data transmission is delayed, throughput, accuracy of data, and the like. More specifically, if a data group puts emphasis on whether or not data transmission is delayed as a data attribute of the data group, an awake period of a discovery window can be configured to be short. In particular, a NAN device performing a non-master role can be frequently awake in a discovery window set to transmit and receive data. On the contrary, if whether or not data transmission is delayed is not regarded as important, the awake period of the discovery window can be configured to be long.

FIG. 17 is a block diagram for a device according to one embodiment of the present specification.

A device may correspond to a NAN device included in a cluster. In this case, as mentioned in the foregoing description, the device can perform a role selected from the group consisting of an anchor master role, a master role, a non-master sync role, and a non-master non-sync role. In particular, the device can perform a plurality of roles under a prescribed condition.

In this case, the device 100 can include a transmission module 110 configured to transmit a radio signal, a reception module 130 configured to receive a radio signal, and a processor 120 configured to control the transmission module 110 and the reception module 130. In this case, the device 100 can perform communication with an external device using the transmission module 110 and the reception module 130. In this case, the external device may correspond to a different device. And, the external device may correspond to a base station. In particular, the external device may correspond to a device capable of performing communication with the device 100, by which the present invention may be non-limited. The device 100 can transmit and receive digital data such as contents using the transmission module 110 and the reception module 130. And, the device 100 can exchange a beacon frame, a service discovery frame, and the like using the transmission module 110 and the reception module 130, by which the present invention may be non-limited. In particular, the device 100 performs communication using the transmission module 110 and the reception module 130 and may be able to exchange information with an external device.

According to one embodiment of the present specification, if the device 100 performs master role, the processor 120 of the device 100 can configure a data group including at least one or more non-master devices. And, the processor 120 sets an awake period of a discovery window and can transmit information on the awake period of the discovery window to the at least one or more non-master devices included in the data group using the transmission module 110. In this case, if the data group corresponds to a first data group, the awake period of the discovery window can be configured by a first period. If the data group corresponds to a second data group, the awake period of the discovery window can be configured by a second period.

According to one embodiment of the present specification, if the device 100 performs an anchor master role, the processor 120 can transmit a synchronization beacon frame to at least one of a master device and a non-master device using the transmission module 110. In this case, the processor 120 can transmit the synchronization beacon frame in every discovery window using the transmission module 110.

According to one embodiment of the present specification, if the device 100 performs a non-master role, the processor 120 can receive a synchronization beacon frame from a master device or a non-master device using the reception module 130. By doing so, the processor 120 can perform synchronization. And, the processor 120 can receive information on an awake period using the reception module 130. By doing so, the processor 120 can configure to be awake in a specific discovery window only in a discovery window set.

The embodiments of the present invention may be achieved by various means, for example, hardware, firmware, software, or a combination thereof.

In a hardware configuration, the methods according to exemplary embodiments of the present invention may be achieved by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, microcontrollers, microprocessors, etc.

In a firmware or software configuration, an embodiment of the present invention may be implemented in the form of a module, a procedure, a function, etc. Software code may be stored in a memory unit and executed by a processor. The memory unit is located at the interior or exterior of the processor and may transmit and receive data to and from the processor via various known means.

Those skilled in the art will appreciate that the present invention may be carried out in other specific ways than those set forth herein without departing from the spirit and essential characteristics of the present invention. The above embodiments are therefore to be construed in all aspects as illustrative and not restrictive. The scope of the invention should be determined by the appended claims and their legal equivalents, not by the above description, and all changes coming within the meaning and equivalency range of the appended claims are intended to be embraced therein.

And, both an apparatus invention and a method invention are explained in the present specification and the explanation on both of the inventions can be complementally applied, if necessary.

### INDUSTRIAL APPLICABILITY

Although the present invention is explained under the assumption that the present invention is applied to IEEE 802.11 based wireless LAN system, by which the present invention may be non-limited. The present invention can be applied to various wireless systems using the same scheme.

What is claimed is:

1. A method of setting an awake period of a discovery window (DW) set by a NAN (neighbor awareness networking) device in a wireless communication system, the method comprising:
setting a data group containing at least one master device; and
setting the awake period of the discovery window set by the master device contained in the data group,
wherein the awake period of the discovery window is configured by a first period when the data group corresponds to a first data group, and
wherein the awake period of the discovery window is configured by a second period when the data group corresponds to a second data group.

2. The method of claim 1,
wherein the awake period of the discovery window is configured based on a discovery window set containing a plurality of discovery windows.

3. The method of claim 2,
wherein the data group further comprises at least one non-master device, wherein the master device is awake in all discovery windows contained in the discovery window set, and
wherein the non-master device is awake in a part of the discovery windows contained in the discovery window set based on the awake period of the discovery window.

4. The method of claim 3,
wherein both the master device and the at least one non-master device are awake in a first discovery window contained in the discovery window set.

5. The method of claim 4,
wherein the first discovery window contained in the discovery window set has a duration longer than a duration of a different discovery window contained in the discovery window set.

6. The method of claim 3,
wherein when the master device is awake in the all discovery windows of the discovery window set, the master device is synchronized with an anchor master device.

7. The method of claim 3,
wherein the master device and the non-master device do not change a role during a first discovery window period and wherein the first discovery window period comprises n number of discovery windows.

8. The method of claim 3,
wherein the master device and the non-master device contained in the same data group exchange information on the awake period of the discovery window with each other by exchanging a service discovery frame.

9. The method of claim 8,
wherein the service discovery frame further comprises information on a frequency used by the master device and the non-master device.

10. The method of claim 1,
wherein the first data group and the second data group are contained in the same cluster and wherein the first data group is distinguished from the second data group based on a data attribute.

11. The method of claim 1,
wherein the awake period of the discovery window is set based on a data attribute and wherein the data attribute is configured based on a latency requirement and a throughput requirement for a data service.

12. A NAN (neighboring awareness networking) device setting an awake period of a discovery window (DW) in a wireless communication system, comprising:
a reception module configured to receive information from an external device;
a transmission module configured to transmit information to an external device; and
a processor configured to control the reception module and the transmission module, wherein the processor is further configured to:
set a data group containing at least one non-master device,
set the awake period of the discovery window,
transmit information on the awake period of the discovery window to the at least one non-master device contained in the data group using the transmission module,
wherein the awake period of the discovery window is configured by a first period when the data group corresponds to a first data group, and
wherein the awake period of the discovery window is configured by a second period when the data group corresponds to a second data group.

13. The NAN device of claim 12,
wherein the processor is further configured to set the awake period of the discovery window based on a discovery window set containing a plurality of discovery windows.

14. The NAN device of claim 13,
wherein the processor is further configured to awake the NAN device in all discovery windows contained in the discovery window set, and
wherein the non-master device is awake in a part of the discovery windows contained in the discovery window set based on the awake period of the discovery window when the non-master device is awake based on the received information on the awake period of the discovery window.

15. The NAN device of claim 14,
wherein both the NAN device and the at least one non-master device are awake in a first discovery window contained in the discovery window set when the non-master device is awake based on the received information on the awake period of the discovery window.
